(19) United States
(12) Patent Application Publication
(10) Pub. No.: US 2001/0027660 A1
(43) Pub. Date: Oct. 11, 2001

(54) Air-conditioning system for motor vehicles, with two separate and independent refrigerating circuits, having heat exchangers on the same air flow line

(75) Inventor: Giorgio Moffa, Beinasco (IT)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Autoclima S.p.A.

(21) Appl. No.: 09/852,242

(22) Filed: May 9, 2001

Related U.S. Application Data
(63) Continuation of application No. PCT/IT99/00367, filed on Nov. 15, 1999.

(30) Foreign Application Priority Data
Nov. 16, 1998 (IT) AT98A000009

(51) Int. Cl. B60H 1/32

(52) U.S. Cl. 62/239

(57) ABSTRACT

The invention has the object of providing an air-conditioning system for motor vehicles or the like, with two separate and independent refrigerating circuits having heat exchangers on the same air flow line, one of the two circuits having its compressor that receives mechanical power from the vehicle engine and thereby can be used when the motor vehicle itself is running, and the other circuit has the relevant compressor that receives mechanical power from an electrical motor which in turn receives power from the mains current and is instead usable during the stop when the vechicle is parked.

### CROSS-REFERENCE TO RELATED APPLICATION

This application is a continuation of International Application No. PCT/IT99/00367, filed Nov. 15, 1999, the disclosure of which is incorporated herein by reference.

### BACKGROUND OF THE INVENTION

The present invention relates to an air-conditioning system for motor vehicles or the like, namely of a closed volume transported by a motor vehicle, in particular formed of two separate and independent refrigerating circuits which can be used separately for operating either when the motor vehicle is running or is stopped.

It is known that the conditioning systems for motor vehicles are essentially formed of a condenser provided with one or more electro-fans, an evaporator also having one or more electro-fans and a compressor which can receive mechanical power from the engine itself of the motor vehicle or either from a supplemental combustion engine or an electric motor being fed by a generator mounted on board or by the mains current; obviously in this latter case the compressor can operate only when the vehicle is stationary and connected to the power mains.

In case of two compressors being present, these are inserted in the same refrigerating circuit and use the same cooling fluid. It is true that theoretically two separate and independent circuits could be found, as disclosed in the U.S. Pat. No. 5,307,645, but till now the relevant compressors were both driven by electrical motors for the purpose of macking up a conditioning system with two stages of refrigerating capacity, to be used during the stop.

In case it is desired to have the system operating when the motor vehicle is both in movement and stopped with the engine off, it is possible to find two compressors operating in the same refrigerating circuit and using the same cooling fluid: the first of them receives mechanical power from the motor vehicle engine and is used during the vehicle running, while the second receives mechanical power from an electrical motor being in turn fed by the mains current and is instead used during the stop.

Although already in the U.S. Pat. No. 3,885,398, of 1975, a compressor is disclosed to be coupled with an electrical motor and another compressor is driven by the vehicle engine, being both inserted in the same refrigerating circuit, it is very difficult to find out compressors coupled with electrical motors which can be directly fed by the mains current and are called “sealed” or “semi-sealed”, being also compatible with the same cooling fluid and the same lubricant of the compressors which are designed to receive mechanical power from a combustion engine, these being instead called of the “open” type. Furthermore the components of the circuit are in common and consequently, since the “open” compressors have variable capacity and speed, different from those of the sealed compressor, it is impossible to obtain the best efficiency with either of them. Therefore for these reasons also the second compressor is often of the “open” type, in order to be compatible with the same cooling and lubricating means of the first compressor, and receives mechanical power from an electrical motor fed by the mains current.

However such a solution is limiting the possibilities of choosing the compressors and may involve drawbacks such as excessive noise—which is typical for open compressors during the functioning with the vehicle parked, the system being more complicated for the need of an additional electrical motor and relevant transmission system of the drive to the compressor, as well as due to lubrication problems: in fact the oil of the compressors is partially swept by the cooling fluid along the refrigerating circuit and, since there are portions of the circuit itself which are excluded during the operation, either when the vehicle is running or stopped, it can happen that an oil fraction remains without flowing in the excluded portion of the circuit instead of returning to the compressor.

### BRIEF SUMMARY OF THE INVENTION

It is therefore an object of the present invention to provide an air- conditioning system for a motor vehicle with two separate and independent refrigerating circuits having heat exchangers on the same air flow line and can be used both in case of running or of stop, such as not to show the above-mentioned drawbacks but a practical and advantageous solution under the points of view of construction and utilization.

This object is achieved, according to the invention, with an air conditioning system for motor vehicles or the like, characterized by providing two separate and independent refrigerating circuits, while maintaining the heat exchangers on the same air flow line, with one of the two circuits having its compressor that receives mechanical power from the vehicle engine and thereby can be used when the motor vehicle itself is running, and the other circuit has the relevant compressor that receives mechanical power from an electrical motor which in turn receives power from the mains current and is instead usable during the stop, with the vehicle being parked.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 schematically shows a conditioning system according to the invention; and

FIG. 2 also schematically shows an embodiment of the conditioning system of the invention, particularly suitable for the air conditioning at the inside of a motor caravan.

### DETAILED DESCRIPTION OF THE INVENTION

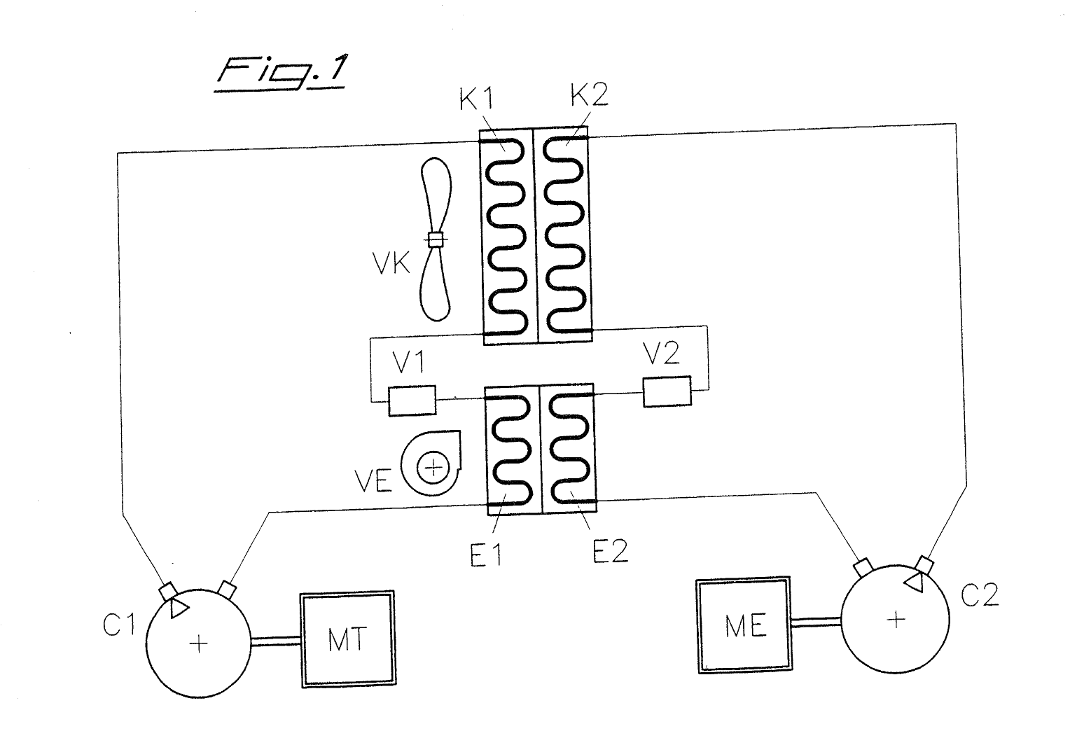

With reference to the drawings and firstly to FIG. 1, a system has been provided comprising two refrigerating circuits having compressors C1 and C2, condensers K1 and K2 with relevant fans VK, lamination devices V1 and V2, and evaporators E1 and E2 with relevant fans VE. The circuits are schematically represented in a simplifield manner, whereby along the circuits there can be usually auxiliary components such as electrovalves for intercepting the cooling fluids, water traps downstream of the condenser or upstream of the compressor, humidity indicators and others. The compressors C1 and C2 can use different cooling and lubricating means. Compressor C1 is driven into rotation by the combustion engine of the motor vehicle MT, while C2 is driven by an electrical motor ME. During the operation with the compressor C1 or C2 the temperatures of the condensation and evaporation of the cooling means can be different as well as the temperatures of the volume to be conditioned.

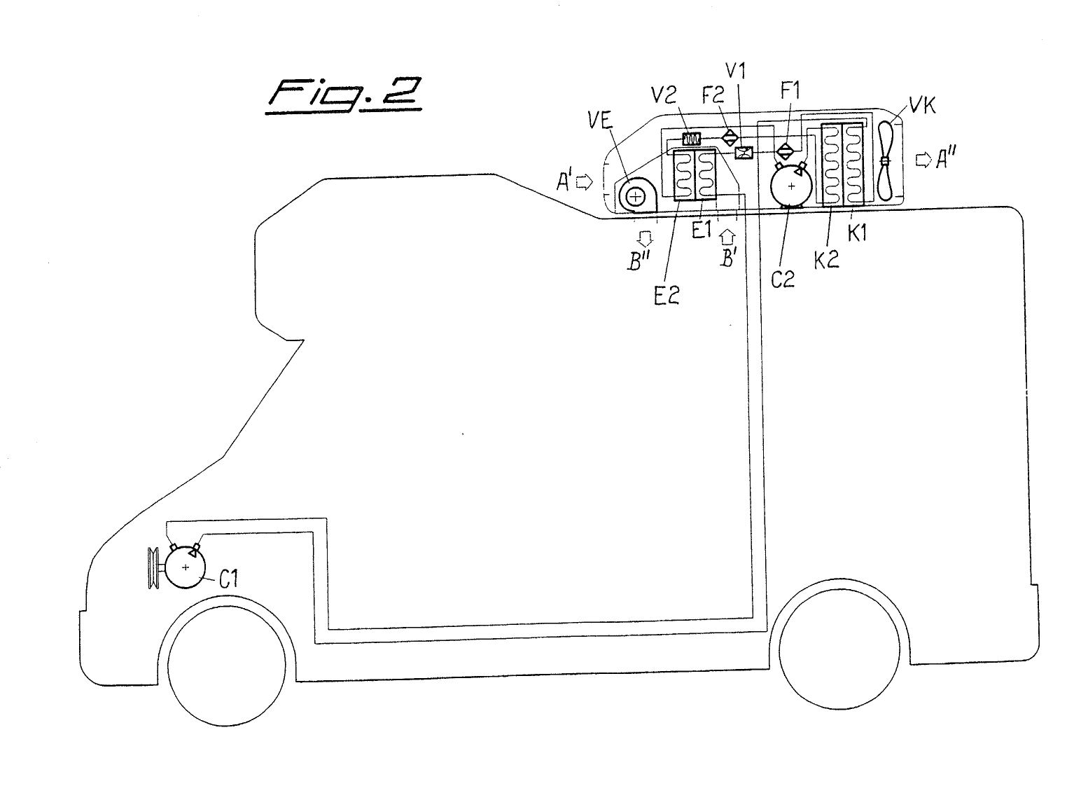

The embodiment of FIG. 2 schematically shows a system according to the invention used for the air conditioning of a motor caravan wherein the compressor named C1 is of the open type and uses a suitable cooling fluid, e.g. R134a, while the compressor named C2 is of the sealed type and uses another cooling fluid, e.g. R22. The compressor C2 is placed within a housing mounted on the vehicle roof wich contains also the heat exchangers K1, K2, E1, E2 and the propeller fans VK and centrifugal fans VE; there are also provided a dehydrating filter F1 having also the function of water trap, a filter F2, a lamination device V1, formed as a thermostatic valve and a second lamination device V2 formed of a tube having a small cross-section. In this case the condensers are so arranged to form two refrigerating lines at the inside of a single radiating mass and the same applies to the evaporators. The compressor C1 is driven into rotation by the combustion engine of the motor vehicle by means of a belt drive transmission and the relevant refrigerating circuit can be suitably used for the air conditioning during the vehicle running; the compressor C2 is fed by the mains current and consequently can be used when the vehicle is stopped and connected to the power mains.

The inlet and outlet of the air flows with respect to the condensers K1 and K2 are respectively indicated by arrows A′ and A″ in FIG. 2. Arrows B′ and B″ are respectively indicating the inlet and outlet of the air flows with respect to the evaporators E1 and E2.

Obviously the invention is not restricted to the above described and illustrated embodiment given by non-limiting example, but can be varied and modified in its entirety and in the single details according to the specific requirements and conveniences of manufacturing and utilization, above all as far as the structure is concerned within the scope of technical and functional equivalence, without exceeding the guiding principle described above and claimed in the following.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An air-conditioning system for motor vehicles or the like, being driven by a combustion engine, with two separate and independent refrigerating circuits, having heat exchangers on the same air flow line and one of the two circuits with a compressor receiving mechanical power from the motor vehicle engine, to be used when the motor vehicle itself is running, characterized in that the compressor of the other circuit receives mechanical power from an electrical motor which in turn is fed by the mains current to be used when the motor vehicle is parked during a stop.

2. An air-conditioning system for motor vehicles or the like according to claim 1, characterized by the fact of comprising an open-type compressor requiring mechanical power from the combustion engine of the motor vehicle, to which it is connected through mechanical transmission means.

3. An air-conditioning system for motor vehicles or the like according to claim 1, characterized by comprising an open-type compressor driven through mechanical power produced by an electrical motor.

4. An air-conditioning system for motor vehicles or the like according to claim 2, characterized by comprising a compressor of the sealed or semi-sealed type driven either by electric power fed from the mains current or by means of an electric generator.

5. An air-conditioning system for motor vehicles or the like according to claim 1, characterized by comprising heat exchangers, condensers or evaporators or both, respectively made with a single radiating mass at the inside of which there are provided respective sections of the two separate refrigerating circuits.

6. An air-conditioning system for motor vehicles or the like according to claim 1, characterized by comprising heat exchangers, either condensers or evaporators or both, respectively consisting, each relevant unit, of two distinct radiating masses, each of them corresponding to the respective section of the refrigerating circuit.

7. An air-conditioning system for motor vehicles or the like according to claim 1, characterized by the fact of using two different cooling fluids in the two refrigerating circuits.

8. An air-conditioning system for motor vehicles or the like according to claim 1, characterized by the fact of using the same cooling fluid in both the refrigerating circuits.

9. An air-conditioning system for motor vehicles or the like according to claim 1, characterized by the fact that one or both of the refrigerating circuits are capable to be used for a heat pump operation, therefore for heating the motor vehicle interior.

10. An air-conditioning system for motor vehicles or the like according to claim 2, in particular for the air-conditioning of motor caravans or the like, wherein a first compressor (C1) is of the open type and uses a first cooling fluid, while the compressor (C2) is of the sealed type and uses a second different cooling fluid, said second compressor (C2) being located at the inside of a housing mounted on the vehicle roof that contains also heat exchangers (K1, K2, E1, E2) as well as propeller fans (VK) and centrifugal fans (VE), also comprising a dehydrating filter (F1), a second filter (F2), laminating devices (V1, V2) with condensers (K1, K2) and evaporators (E1, E2), whereby two refrigerating lines are formed within a single radiating mass, said compressor (C1) being driven to rotation by the combustion engine of the vehicle by means of a belt drive, the relevant circuit including said compressor (C1) being adapted to be used for the air conditioning when the said vehicle is running, while the second compressor (C2) is fed by the mains current, thus being used when the vehicle is stationary and connected to said mains.
